(19) United States
(12) Patent Application Publication
(10) Pub. No.: US 2009/0248960 A1
(43) Pub. Date: Oct. 1, 2009

(54) METHODS AND SYSTEMS FOR CREATING AND USING VIRTUAL FLASH CARDS

(75) Inventors: Mari Sunderland, Alameda, CA (US); Christine Denniston, San Francisco, CA (US); Sullivan Parker, San Francisco, CA (US)

Correspondence Address: MURABITO, HAO & BARNES, LLP, TWO NORTH MARKET STREET, THIRD FLOOR, SAN JOSE, CA, 95113, US

(73) Assignee: LEAPFROG ENTERPRISES, INC., Emeryville, CA (US)

(21) Appl. No.: 12/121,521

(22) Filed: May 15, 2008

Related U.S. Application Data
(60) Provisional application No. 61/039,341, filed on Mar. 25, 2008.

(51) Int. Cl. G06F 12/02

(52) U.S. Cl. 711/103; 711/E12.008

(57) ABSTRACT

Creating and using virtual flash cards is disclosed. A disclosed method includes receiving an input of sets of flash data into a portable handheld device, associating related sets of the flash data based on manual inputs that define the relationship between the related sets of flash data, presenting one of the related sets of flash data via the handheld device and prompting a selection of a set of flash data that is associated with the presented set of flash data. Feedback is provided that indicates whether or not a selected set of flash data is correct.

### BACKGROUND

Flash cards are cards that have words, numbers or pictures printed on their surfaces. Flash cards can be “flashed” or briefly displayed as a part of classroom learning drills or as a part of self-directed learning drills. Flash cards can be useful as effective learning aids for many subjects and can be used to help students from preschool to college aged. Flash cards can generally be purchased at bookstores or where other types of educational materials are sold.

Some flash card creation services are available online. These services include online websites that allow users to create, share, study and print flash cards from their computer terminals, e.g., desktop or laptop computers. One such online service allows a user to view words that are selected from a dictionary on the user's computer terminal and to enter text, or select an answer from a list of several answer variants, in response to the displayed words. This online service can be useful to students and others who seek assistance with the memorization of terms and their definitions, and who are, for example, preparing for an examination.

Conventional flash card products have inherent shortcomings. Using conventional flash card products generally involves the physical handling of the flash cards. Moreover, the permanent storage of such cards, which in some cases can involve a substantial number, can be troublesome. Accordingly, using and maintaining conventional flash card products can be inconvenient.

Conventional online or other computer based flash card creation systems are limited in that they result in the creation (print out) of paper based flash cards that have essentially the same drawbacks as commercially available flash cards discussed above. Moreover, online flash card quizzing services tie the service user to the computer system that is used to access the online service. These conventional services can prove unsatisfactory for many consumers who desire more convenient and user friendly products.

### SUMMARY

A system that enables the creation and use of virtual flash cards using non-conventional methods would be advantageous. Embodiments of the present invention provide such a system, as well as methods and applications that can be implemented using such a system.

In one embodiment, virtual flash cards can be created and used with portable computer platforms. In one embodiment, after relationships between content (flash data) on respective “sides” of a virtual flash card are established (e.g., for a category “name state capitals” the state name on one “side” of the virtual flash card and the state capital name on the other “side”), the virtual flash cards can be used to quiz users regarding flash data associations. In one embodiment, an optical pen based computer system can be used to “read out,” in the form of an audio recitation, the flash data (e.g., “California”) from one “side” of a virtual flash card and to cue a user to write down or scan the correct associated flash data (e.g., “Sacramento”) from the other “side” of the virtual flash card as an answer. The flash data that is read out by the pen computer may be located on encoded media.

In one embodiment, the pen computer can provide audio feedback that communicates whether or not an answer that is provided by a user is correct. Additionally, the pen computer can track the percentage of correct answers provided by a user and can automatically determine with which topics a user is having trouble. The system can responsively increase the frequency at which flash cards related to problematic topics are presented or “read out.”

In another embodiment, a portable flash card module that may include an audio player capability can be employed in the creation and use of virtual flash cards. In one embodiment, the portable flash card module has sufficient memory for hundreds of songs or more, and thousands of flash cards.

In one embodiment, a user can navigate between the aforementioned audio player, e.g., mp3, modality and a flashcard modality by utilizing a menu that can be accessed through the use of buttons, such as an “enter” button located on the handheld module and a display screen (with screen rocker). When the flash card modality is entered into, music can continue to be played back or can be caused to be terminated. In one embodiment, once the flash card modality is entered into, deflecting the display screen can control flash card functionality that includes but is not limited to the presenting of a next card or a previous card and the flagging of a particular card.

In one embodiment, relationships between flash data associated with virtual flash cards that are created by a user at online sources can be transferred from online sources to the portable flash card module where the virtual flash cards can be displayed on the display screen. Moreover, instead of, or in addition to being created online, the virtual flash cards can be provided by a vendor. In one embodiment, the system can be customized as flash cards that relate to non-conventional topics that are of interest to a user can be created (e.g., flash cards that help user to learn names of one's family members).

In one embodiment, after relationships between flash data have been established and transferred to the portable flash card module, the resultant virtual flash cards can be used to quiz users. In one embodiment, the portable flash card module can be used to present flash data (flash card content) to a user and to cue (using either visual or audio prompts) a user to identify the flash data (flash card content) that is associated with the flash data that has been presented.

In one embodiment, the flashcards can be sorted according to topic area such as history, geography, mathematics, vocabulary, etc. Moreover, a user can customize interaction with the system by adding sub-categories to a topic area that is already categorized according to the user's wishes. In one embodiment, the flash cards that are presented can be two sided and can be flagged such as by using “bent ear corner” graphics. In addition, flash cards can have images or sound associated with them (such as an image of a dog on one side of a virtual flash card and the Spanish language term for “dog” on the other side of the virtual flash card).

In one embodiment, methods and systems for creating and using virtual flash cards are disclosed. A disclosed method includes receiving an input of sets of flash data into a portable handheld device, associating related sets of the flash data based on manual inputs that define the relationship between the related sets of flash data and presenting one of the related sets of flash data via the handheld device. Thereafter, a selection of a set of flash data that is associated with the presented set of flash data is prompted. Moreover, feedback is provided that indicates whether or not a selected set of flash data is correct.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an optical device with which a system for creating and using virtual flash cards can be used according to one embodiment of the present invention.

FIG. 2 illustrates a portion of an item of encoded media with which a system for creating and using virtual flash cards can be used according to one embodiment of the present invention.

FIG. 3 illustrates an example of an item of encoded media with added content according to one embodiment of the present invention.

FIG. 4A shows an exemplary operating environment of a system for creating and using virtual flash cards according to one embodiment of the present invention.

FIG. 4B shows another exemplary operating environment according to one embodiment of the present invention.

FIG. 4C illustrates the operation of system for creating and using virtual flash cards according to one embodiment.

FIG. 5A shows a computer system upon which virtual flash cards can be created and a handheld virtual flash card control module upon which components of system for creating and using virtual flashcards can operate according to one embodiment of the present invention.

FIG. 5B illustrates the flipping of virtual flash cards according to one embodiment of the present invention.

FIG. 5C shows a perspective view of a virtual flash card control module according to one embodiment of the present invention.

FIG. 5D shows a virtual flash card control module according to one embodiment of the present invention.

FIG. 6 shows components a system for creating and using virtual flash cards according to one embodiment of the present invention.

FIG. 7 shows a flowchart of the steps performed in a computer controlled method for creating and using virtual flash cards according to one embodiment.

### DETAILED DESCRIPTION OF THE INVENTION

In the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

### Notation and Nomenclature

Some portions of the detailed descriptions, which follow, are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

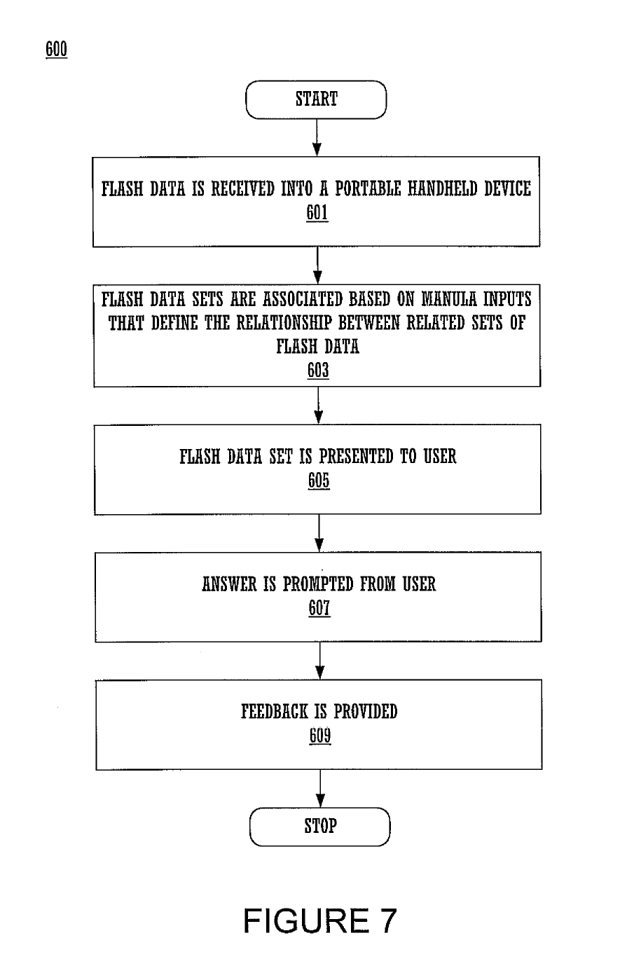

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “sensing” or “scanning” or “storing” or “defining” or “associating” or “receiving” or “selecting” or “generating” or “creating” or “decoding” or “invoking” or “accessing” or “retrieving” or “identifying” or “prompting” or the like, refer to the actions and processes of a computer system (e.g., flowchart 700 of FIG. 7), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Computer System Environment of System for Creating and Using Virtual Flash Cards

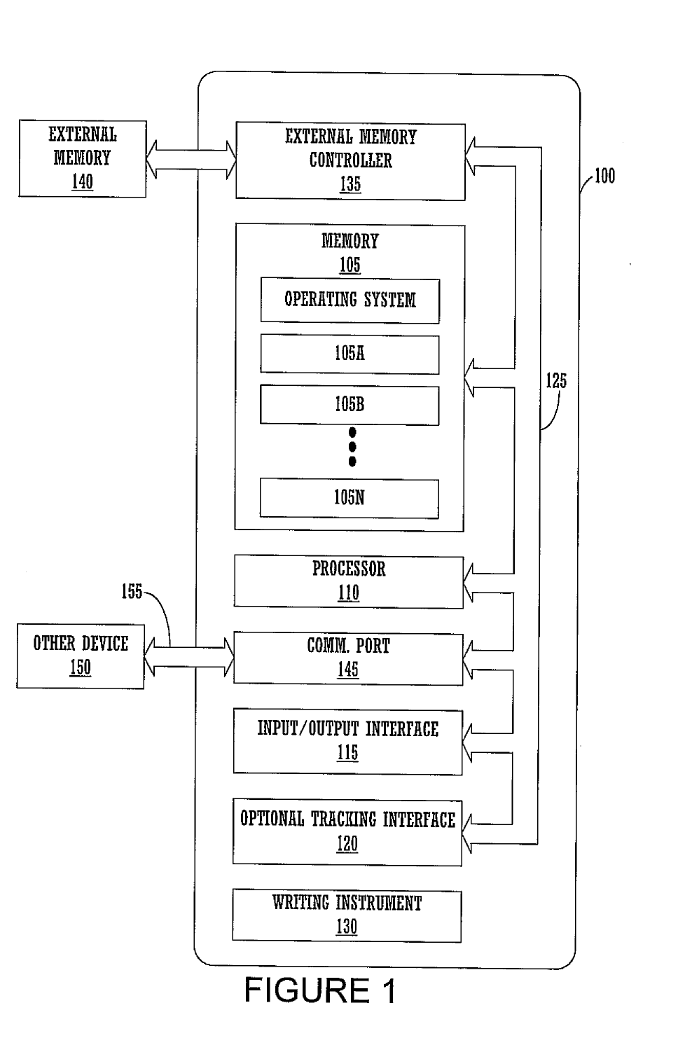

FIG. 1 is a block diagram of a computing device 100 upon which embodiments of the present invention can be implemented. In general, device 100 may be referred to as a pen-shaped computer system or pen computer or an optical device, or more specifically as an intelligent or computerized optical reader, optical pen or digital pen. In general, device 100 may have a form factor similar to a pen, stylus or the like.

Devices such as optical readers or optical pens emit light that can be reflected off of a surface for receipt by a detector or imager. As the device is moved relative to the surface, successive images can be rapidly captured. By analyzing the images, the movement of the optical device relative to the surface can be tracked.

According to embodiments of the present invention, device 100 can be used with a sheet of “digital paper” on which a coded pattern of markings—specifically, very small dots—are printed. Digital paper may also be referred to herein as encoded media or encoded paper. In one embodiment, the dots can be printed on paper in a proprietary pattern with a nominal spacing of about 0.3 millimeters (0.01 inches). In one such embodiment, the pattern consists of 669,845,157,115,773,458,169 dots, and can encompass an area exceeding 4.6 million square kilometers, corresponding to about 73 trillion letter-size pages. This “pattern space” is subdivided into regions that are licensed to vendors (service providers)—where each region is unique from other regions. In this manner, service providers are licensed pages of the pattern that are exclusively for their use. Different parts of the pattern can be assigned different functions.

In one embodiment, in operation, an optical pen such as device 100 can take snapshots of the surface of the aforementioned digital paper. By interpreting the positions of the dots captured in each snapshot, device 100 can precisely determine its position on a page of the digital paper in two dimensions. That is, device 100 can determine an x-coordinate and a y-coordinate position of the device relative to the page (based on a Cartesian coordinate system). The pattern of dots allows the dynamic position information coming from the optical sensor/detector in device 100 to be translated into signals that are indexed to instructions or commands that can be executed by a processor in the device.

In the FIG. 1 example, device 100 includes system memory 105, processor 110, input/output interface 115, optical tracking interface 120, one or more buses 125 and a writing instrument 130 that projects from the device housing. System memory 105, processor 110, input/output interface 115 and optical tracking interface 120 are communicatively coupled to each other by the one or more buses 125.

Memory 105 can include one or more types of computer-readable media, such as static or dynamic read only memory (ROM), random access memory (RAM), flash memory, magnetic disk, optical disk and/or the like. Memory 105 can be used to store one or more sets of instructions and data that, when executed by the processor 110, cause the device 100 to perform the functions described herein. In one embodiment, one such set of instructions can include a system for creating and using virtual flash cards 105N.

Device 100 can further include an external memory controller 135 for removably coupling an external memory 140 to the one or more buses 125. Device 100 can also optionally include one or more communication ports 145 communicatively coupled to the one or more buses 125. The one or more communication ports can be used to communicatively couple device 100 to one or more other devices 150. Device 110 may be communicatively coupled to other devices 150 by either wired and/or a wireless communication link 155. Furthermore, the communication link may be a point-to-point connection and/or a network connection.

Input/output interface 115 can include one or more electro-mechanical switches operable to receive commands and/or data from a user. Input/output interface 115 can also include one or more audio devices, such as a speaker, a microphone, and/or one or more audio jacks for removably coupling an earphone, headphone, external speaker and/or external microphone. The audio device is operable to output audio content and information and/or receiving audio content, information and/or instructions from a user. Input/output interface 115 can include video devices, such as a liquid crystal display (LCD) for displaying alphanumeric and/or graphical information and/or a touch screen display for displaying and/or receiving alphanumeric and/or graphical information.

Optical tracking interface 120 includes a light source or optical emitter and a light sensor or optical detector. The optical emitter can be a light emitting diode (LED) and the optical detector can be a charge coupled device (CCD) or complementary metal-oxide semiconductor (CMOS) imager array, for example. The optical emitter is used to illuminate a surface of a media or a portion thereof and light reflected from the surface is received at the optical detector.

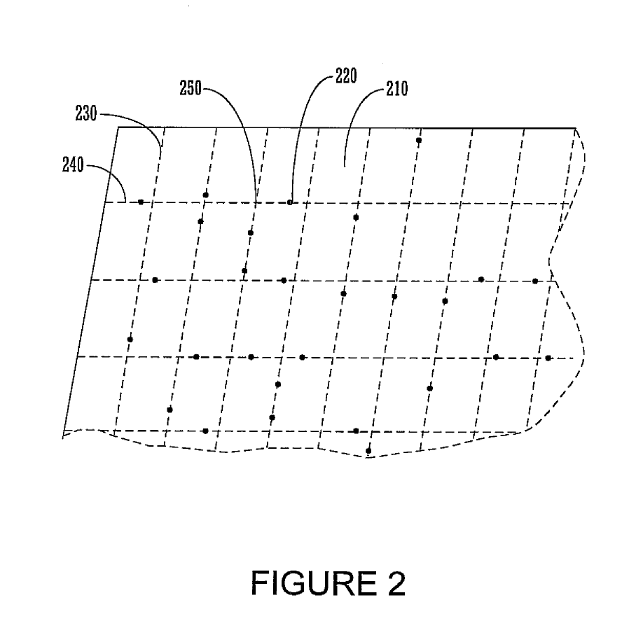

The surface of the media can contain a pattern detectable by the optical tracking interface 120. Referring now to FIG. 2, shown is an example of a type of encoded media 210, which can be used in embodiments of the present invention. Media 210 can include a sheet of paper, although surfaces consisting of materials other than, or in addition to, paper can be used. Media 210 can be a flat panel display screen (e.g., an LCD) or electronic paper (e.g., reconfigurable paper that utilizes electronic ink). Also, media 210 may or may not be flat. For example, media 210 can be embodied in the surface of a globe.

Media 210 can be smaller or larger than a conventional (e.g., 8.5×11-inch) page of paper. In general, media 210 can be any type of surface upon which markings (e.g., letters, numbers, symbols, etc.) can be printed or otherwise deposited, or media 210 can be a type of surface wherein a characteristic of the surface changes in response to action on the surface by device 100.

In one implementation, the media 210 is provided with a coding pattern in the form of optically readable position code that consists of a pattern of dots. As the writing instrument 130 and the optical tracking interface 120 move together relative to the surface, successive images are captured. The optical tracking interface 120 (specifically, the optical detector) can take snapshots of the surface at a rate of 100 times or more per second. By analyzing the images, position on the surface and movement relative to the surface of the media can be tracked.

In one implementation, the optical detector fits the dots to a reference system in the form of a raster with raster lines 230 and 240 that intersect at raster points 250. Each of the dots 220 is associated with a raster point. For example, the dot 220 is associated with raster point 250. For the dots in an image, the displacement of a dot 220 from the raster point 250 associated with the dot 220 is determined. Using these displacements, the pattern in the image is compared to patterns in the reference system. Each pattern in the reference system is associated with a particular location on the surface. Thus, by matching the pattern in the image with a pattern in the reference system, the position of the device 100 (FIG. 1) relative to the surface can be determined.

With reference to FIGS. 1 and 2, by interpreting the positions of the dots 220 captured in each snapshot, the operating system and/or one or more applications executing on the device 100 can precisely determine the position of the device 100 in two dimensions. As the writing instrument and the optical detector move together relative to the surface, the direction and distance of each movement can be determined from position data.

In addition, different parts of the pattern of markings can be assigned different functions, and software programs and applications may assign functionality to the various patterns of dots within a respective region. Furthermore, by placing the optical detector in a particular position on the surface and performing some type of actuating event, a specific instruction, command, data or the like associated with the position can be entered and/or executed. For example, the writing instrument 130 can be mechanically coupled to an electro-mechanical switch of the input/output interface 115. Therefore, in one embodiment, for example, double-tapping substantially the same position can cause a command assigned to the particular position to be executed.

The writing instrument 130 of FIG. 1 can be, for example, a pen, pencil, marker or the like, and may or may not be retractable. In one or more instances, a user can use writing instrument 130 to make strokes on the surface, including letters, numbers, symbols, figures and the like. These user-produced strokes can be captured (e.g., imaged and/or tracked) and interpreted by the device 100 according to their position on the surface on the encoded media. The position of the strokes can be determined using the pattern of dots on the surface of the encoded media as discussed above.

A user, in one embodiment, can use writing instrument 130 to create a character, for example, an “M” at a given position on the encoded media. In this embodiment, the user may or may not create the character in response to a prompt from computing device 100. In one embodiment, when the user creates the character, device 100 records the pattern of dots that are uniquely present at the position where the character is created. Moreover, computing device 100 associates the pattern of dots with the character just captured. When computing device 100 is subsequently positioned over the “M,” the computing device 100 recognizes the particular pattern of dots associated therewith and recognizes the position as being associated with “M.” Accordingly, computing device 100 actually recognizes the presence of the character using the pattern of markings at the position where the character is located, rather than by recognizing the character itself.

In another embodiment, strokes can instead be interpreted by device 100 using optical character recognition (OCR) techniques that recognize handwritten characters. In one such embodiment, computing device 100 analyzes the pattern of dots that are uniquely present at the position where the character is created (e.g., stroke data). That is, as each portion (stroke) of the character “M” is made, the pattern of dots traversed by the writing instrument 130 of device 100 are recorded and stored as stroke data. Using a character recognition application, the stroke data captured by analyzing the pattern of dots can be read and translated by device 100 into the character “M.” This capability can be useful for applications such as, but not limited to, text-to-speech and phoneme-to-speech synthesis.

In another embodiment, a character is associated with a particular command. For example, a user can write a character composed of a circled “M” that identifies a particular command, and can invoke that command repeatedly by simply positioning the optical detector over the written character. In other words, the user does not have to write the character for a command each time the command is to be invoked; instead, the user can write the character for a command one time and invoke the command repeatedly using the same written character.

In another embodiment, the encoded paper can be preprinted with one or more graphics at various locations in the pattern of dots. For example, the graphic can be a preprinted graphical representation of a button. The graphics lies over a pattern of dots that is unique to the position of the graphic. By placing the optical detector over the graphic, the pattern of dots underlying the graphics are read (e.g., scanned) and interpreted, and a command, instruction, function or the like associated with that pattern of dots is implemented by device 100. Furthermore, some sort of actuating movement may be performed using the device 100 in order to indicate that the user intends to invoke the command, instruction, function or the like associated with the graphic.

In yet another embodiment, a user can identify information by placing the optical detector of the device 100 over two or more locations. For example, the user can place the optical detector over a first location and then over a second location to specify a bounded region (e.g., a box having corners corresponding to the first and second locations). In this example, the first and second locations identify the information lying within the bounded region. In another example, the user may draw a box or other shape around the desired region to identify the information. The content within the region can be present before the region is selected, or the content can be added after the bounded region is specified.

Additional information is provided by the following patents and patent applications, herein incorporated by reference in their entirety for all purposes: U.S. Pat. No. 6,502,756; U.S. patent application Ser. No. 10/179,966 filed on Jun. 26, 2002; WO 01/95559; WO 01171473; WO 01/75723; WO 01/26032; WO 01/75780; WO 01/01670; WO 01/75773; WO 01/71475; WO 01/73983; and WO 01/16691. See also Patent Application No. 60/4561053 filed on Mar. 18, 2003, and patent application Ser. No. 10/803,803 filed on Mar. 17, 2004, both of which are incorporated by reference in their entirety for all purposes.

### Exemplary Encoded Media

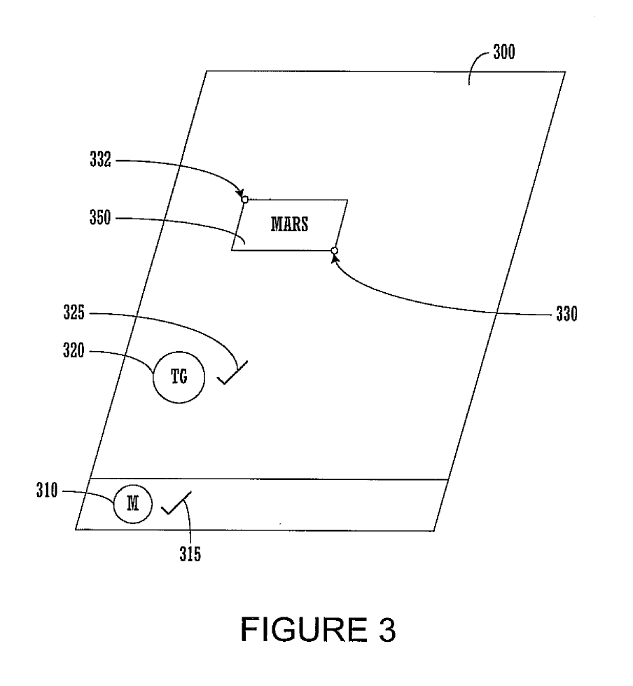

FIG. 3 illustrates an example of an item of encoded media 300 according to one embodiment of the present invention. In FIG. 3, media 300 is encoded with a pattern of markings (e.g., dots) that can be decoded to identify unique positions on its surface, as discussed above.

Referring to FIG. 3, graphic element 310 is preprinted on the surface of media 300. A graphic element can be referred to as an icon. In one embodiment, there can be more than one preprinted element on media 300. Associated with element 310 is a particular function, instruction, command or the like. As described previously herein, underlying the region covered by element 310 is a pattern of markings (e.g., dots) unique to that region. In one embodiment, a second element (e.g., a checkmark 315) is associated with element 310. Checkmark 315 is generally positioned in proximity to element 310 to suggest a relationship between the two graphic elements.

By placing the optical detector of device 100 (FIG. 1 ) anywhere within the region encompassed by element 310, a portion of the underlying pattern of markings sufficient to identify that region can be sensed and decoded, and the associated function, etc., can be invoked. In general, device 100 can simply be brought into contact with any portion of the region encompassed by element 310 (e.g., element 310 is tapped with device 100) in order to invoke a corresponding function, etc. Alternatively, the function, etc., associated with element 310 can be invoked using checkmark 315 (e.g., by tracing, tapping or otherwise sensing checkmark 315), by double-tapping element 310, or by some other type of actuating movement.

In one embodiment, there can be multiple levels of functions, etc., associated with a single graphic element such as element 310. For example, element 310 can be associated with a list of functions, etc.—each time device 100 scans (e.g., taps) element 310, the name of a function, command, etc., in the list is presented to the user. In one embodiment, the names in the list can be vocalized or otherwise made audible to the user. To select a particular function, etc., from the list, an actuating movement of device 100 can be made. In one embodiment, the actuating movement includes tracing, tapping, or otherwise sensing the checkmark 315 in proximity to element 310.

In the FIG. 3 embodiment, a user can also activate a particular function, application, command, instruction or the like by using device 100 to draw elements such as graphic element 320 and checkmark 325 on the surface of media 300. In other words, a user can create handwritten graphic elements that function in the same way as the preprinted ones. A checkmark 325 hand drawn in proximity to element 320 can be used as described above if there are multiple levels of commands, etc., associated with the element 320. The function, etc., associated with element 320 can be initially invoked by the mere act of drawing element 320, it can also be invoked using checkmark 325, by double-tapping element 320, or by some other type of actuating action.

A region 350 can be defined on the surface of media 300 by using device 100 to draw the boundaries of the region. Alternatively, a rectilinear region 350 can be defined by touching device 100 to the points 330 and 332 (in which case, lines delineating the region 350 are not visible to the user).

In the example of FIG. 3, the word “Mars” is handwritten by the user in region 350. The word “Mars” may be generally referred to herein as the content of region 350. That is, although region 350 also includes the pattern of markings described above in addition to the word “Mars,” for simplicity of discussion the term “content” can be used herein to refer to the information in a region that is located there in addition to the pattern of markings associated with that region.

Importantly, the content of region 350 can be created either before or after region 350 is defined. That is, for example, a user can first write the word “Mars” on the surface of media 300 (using either device 100 of FIG. 1 or any type of writing utensil) and then use device 100 to define a region that encompasses that content. Alternately, the user can first define a region using device 100 and then write the word “Mars” within the boundaries of that region (the content can be added using either device 100 or any type of writing utensil).

Although content can be added, using either device 100 or another writing utensil, adding content using device 100 permits additional functionality. In one embodiment, as discussed above, stroke data can be captured by device 100 as the content is added. Device 100 can analyze the stroke data to in essence read the added content. Then, using text-to-speech synthesis (TTS) or phoneme-to-speech synthesis (PTS), the content can be subsequently verbalized.

For example, the word “Mars” can be written in region 350 using device 100. As the word is written, the stroke data is captured and analyzed, allowing device 100 to recognize the word as “Mars.”

In one embodiment, stored on device 100 is a library of words along with associated vocalizations of those words. If the word “Mars” is in the library, device 100 can associate the stored vocalization of “Mars” with region 350 using TTS. If the word “Mars” is not in the library, device 100 can produce a vocal rendition of the word using PTS and associate the rendition with region 350. In either case, device 100 can then render (make audible) the word “Mars” when any portion of region 350 is subsequently sensed by device 100.

### Additional Nomenclature

In the discussions that follow, the term “virtual flash card” is intended to refer to a virtual card (presented as an vocal “card” that is output from a device or a visual card shown on a display) that correlates sets of related information such as “what is the capital of California” or “Sacramento.” In one embodiment, one set of related information such as “Sacramento” is presented to a system user and the user is prompted to attempt to provide the other set of related information (“what is the capital of California” or “California”). Moreover, the term “set of flash data” as used herein is intended to refer to one set of information that is part of a pair of related sets of information that is “presented” to or “flashed” to a user such as, in the above example, either “what is the capitol of California” or “Sacramento.” As used herein, with regard to optical pen embodiments, the term “presented” is intended to refer to the vocal recitation of flash data content that is “read out” or otherwise rendered via optical pen speakers.

### Exemplary Operating Environment of System for Creating and Using Virtual Flash Cards

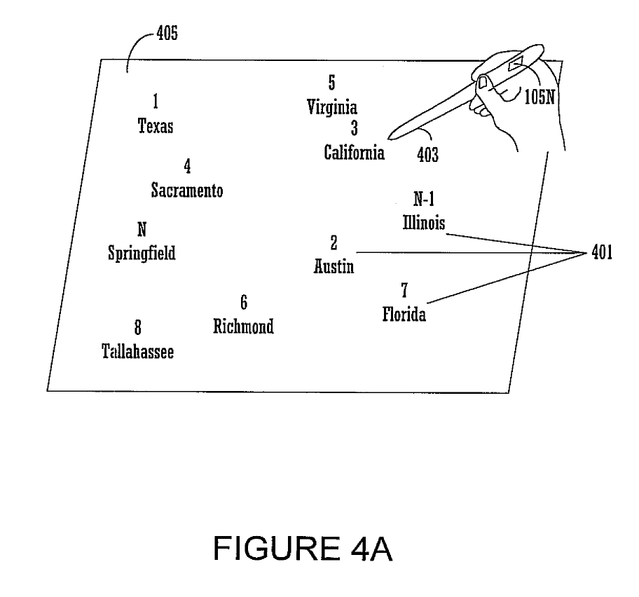

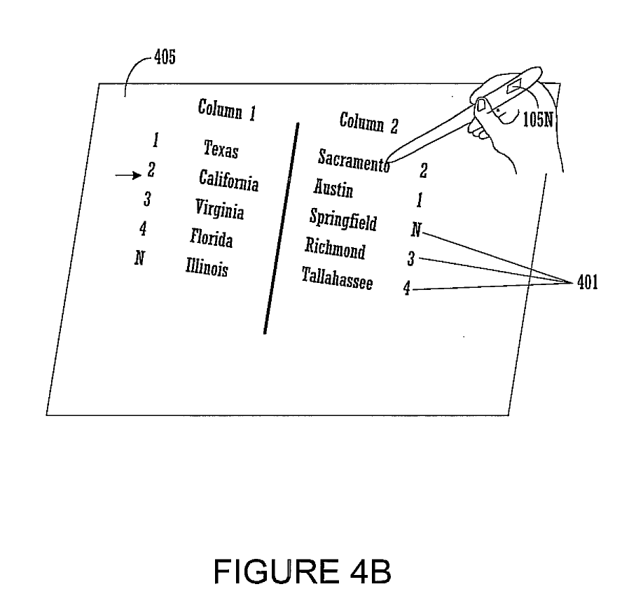

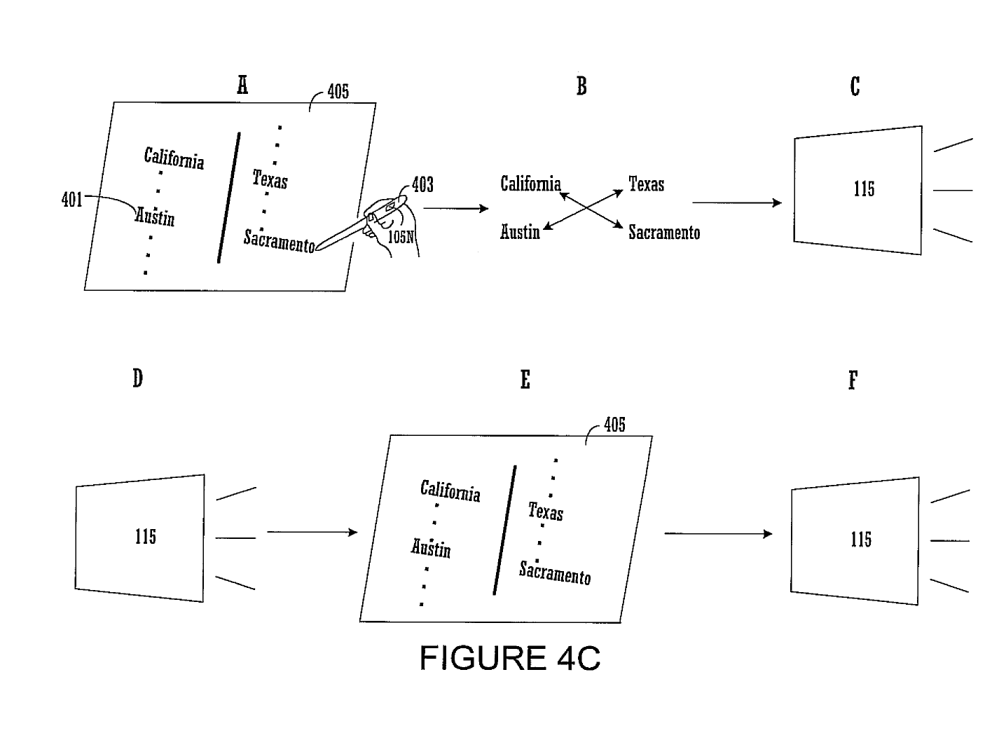

FIG. 4A shows elements of an exemplary operating environment of a system 105N for creating and using virtual flash cards according to one embodiment of the present invention. The elements of the exemplary operating environment enable the creation and use of virtual flash cards. In the FIG. 4A embodiment, elements of the operating environment of the virtual flashcard system 105N include flash data 401, optical pen 403, SCUFC 105N, and encoded media 405.

In one embodiment, virtual flash cards can be created by placing onto encoded media 405 sets of flash data 401 that can be correlated into pairs that form opposite sides of virtual flash cards. In one embodiment, examples of the types of flash data 401 that can be correlated can include but are not limited to related data pairs such as state and state capital, word and definition, question and answer, etc. In one embodiment, sets of flash data 401 can be provided for correlation by writing the flash data (words, letters, numbers etc.) onto encoded media 405 using device 403 and simultaneously scanning the characters placed thereon with optical pen 403. In one embodiment, flash data 401 can be recognized either by a character recognition engine resident on optical pen 403 or by virtue of the location of the flash data 401 on encoded media 409 through processes described herein.

In one embodiment, flash data 401 pairs can be correlated based on their placement order onto encoded media 405 in a sequence of sets of flash data 401 placements that are made onto encoded media 405. In one embodiment, various types of placement order correlation schemes can be designated by a user (or another setting up a quiz or other type virtual flash card session) such as by making a selection using a component that is (button etc. on optical pen 403) appurtenant to optical pen 403.

For example, where flash data 401 includes a word or a phrase, a user can designate that a first word or phrase written onto encoded media 405 be associated with the next word or phrase that is written onto encoded media 405 to form opposite sides of a virtual flash card. Referring to FIG. 4A, in the shown sequence of flash data 401 placements onto encoded media 405, every other set of flash data 401 (Texas, California, Virginia, etc.) written onto encoded media 405 is caused to be associated with the next set of flash data (word or phrase) that is placed onto encoded media 405 (Austin, Sacramento, Richmond) (in FIG. 4A numbers 1-7 indicate the order in which the flash data was written onto encoded media).

As shown in FIG. 4A, when a set of flash data 401 (e.g., California) is designated to be associated with the next set of flash data 401 (e.g., Sacramento) that is placed onto encoded media 405 as discussed above, the two sets of flash data can be automatically correlated within memory units of device 403 without regard to the location of their placement on encoded media 405. In this manner, when a user is, at some later point in time, prompted to identify a set of flash data 401 that corresponds to a set of flash data 401 that has been presented to them, or “flashed” the physical proximity of flash data sets 401 placed onto encoded media 405 do not provide a clue as to the identity of the set of flash data 401 that corresponds to the set of flash data 401 that has been presented.

In another embodiment, referring to FIG. 4A, sets of flash data 401 can be randomly written onto encoded media as shown. Subsequently, sets of flash data 401 can be tapped (e.g., scanned with optical pen) to indicated which sets of flash data are to be associated as respective sides of a virtual flash card.

In another embodiment, based upon a correspondence of placement order in two sequences of N sets of flash data 401 placed onto encoded media 405, each set of flash data in a first sequence of N sets of flash data 401 placed onto encoded media 405 can be associated respectively with the next sequence of N sets of flash data 401 that are placed onto encoded media 405 to form opposite sides of N virtual flash cards.

For example, FIG. 4B shows first and second columns each having N rows that are designated (such as by drawing/writing using optical pen 403) on encoded media 405 for placing N sets of flash data 401 from first and second sequences of flash data 401. In one embodiment, as illustrated with reference to FIG. 4B, corresponding sets of flash data 401 can be correlated even though the row order of a set of flash data 401 from the first sequence of flash data 401 placed into the first column is different from the row order of a corresponding set of flash data 401 from the other sequence of flash data 401 that is placed into the second column. This is true since a correspondence of placement order of sets of flash data 401 in a sequence of flash data 401 placed onto encoded media 405 determines the sets of flash data 401 that are associated and not row order (numbers 1-N indicate the order in which the flash data in a column was placed into the column).

In this manner, when a user is later prompted to identify a set of flash data 401 from, for example, the second column that corresponds to another set of flash data 401 that is located in the first column that has been presented to the user, the placement of the respective sets of flash data 401 in the first and second columns do not provide a clue as to the identity of the set of flash data 401 that corresponds to the set of flash data 401 that has been presented.

In another embodiment, a user can be initially prompted to draw a straight line down the middle of encoded media 405 by optical pen 403 (similar to the line in FIG. 4B). In this embodiment, the user can be prompted by an audio direction that is output from optical pen 405 such as “draw a straight vertical line on paper.” Next, a direction from optical pen 405 such as “prepare first set of flash cards by placing states in column at the left and corresponding state capitals in the column to the left” can be given. In this embodiment, system 105N can determine the correlation by virtue of the placement of related flash data in adjacent columns. In one embodiment, once the flash data has been correlated, system 105N can direct optical pin 403 to create virtual flash cards for quizzing a system user (e.g., student) regarding the data associations.

In one embodiment, optical pen 403 can provide immediate feedback to a system user regarding correctness of an answer. Moreover, in one embodiment, system 105N can direct optical pen 403 to track the percentage of flash data correlations that a user answers correctly. In this manner, system 105N can automatically determine the associations that are problematic for a user and can increase the frequency with which these associations are examined.

In one embodiment, a set of flash data 401 can be traversed by optical pen 403 in order to identify (such as in response to a prompt or a cue from system 105N) the set of flash data 401 located on encoded media 405 that corresponds to a set of flash data 401 that has been presented. In one embodiment, snapshots of the surface of encoded media 405 that includes the identified set of flash data 401 can be taken by an optical tracking interface (e.g., 120 in FIG. 1) that is a component of optical pen 403. By analyzing the images, the position on the encoded surface and the movement of optical pen 403 relative to the encoded surface can be tracked and identified. In this manner, a selection of a set of flash data 401 can be determined.

More specifically, in one embodiment, regions encompassed by sets of flash data on encoded media 405, correspond to particular locations on encoded media 405 that can be correlated to the sets of flash data 401. Encoded media 405 can be thereafter read using optical pen 403, to cause the identification of sets of flash data 401.

Optical pen 403 facilitates the identification of flash data as a response to prompts from system 105N to identify flash data that corresponds to flash data that is presented by system 105N. Moreover, optical pen can provide feedback (e.g., audio) from the system 105N related to the correctness of the response. In one embodiment, optical pen 403 can be held by a user in a manner similar to the manner in which ordinary writing pens are held. In one embodiment, optical pen 403 can include components similar to those included in device 100 described herein with reference to FIG. 1. For purposes of clarity and brevity these components will not be discussed again here.

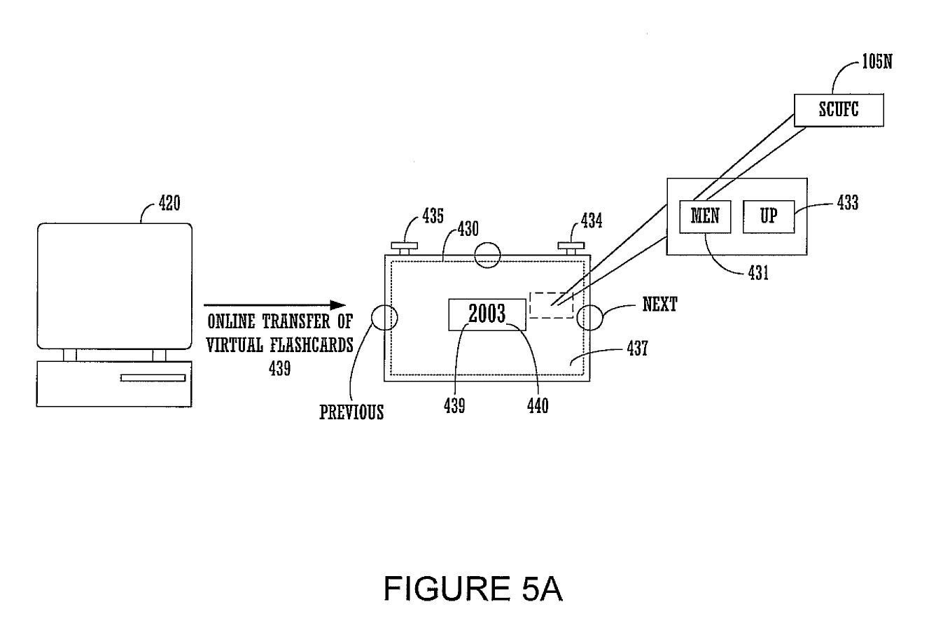

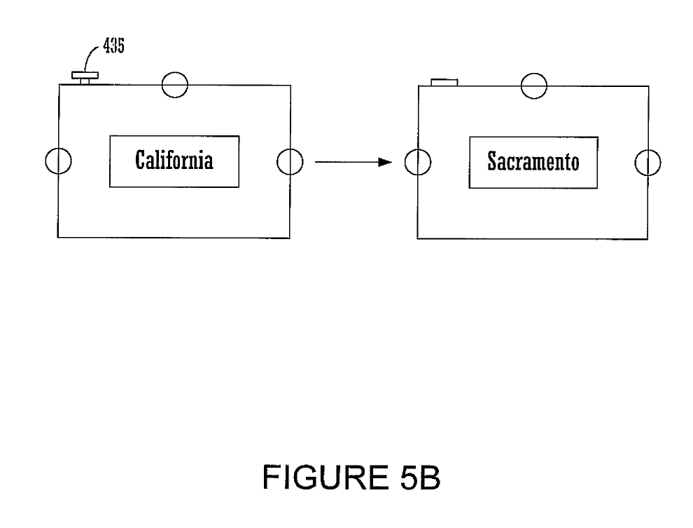

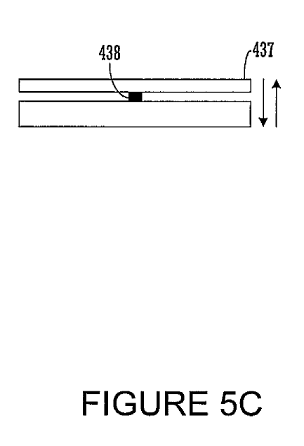

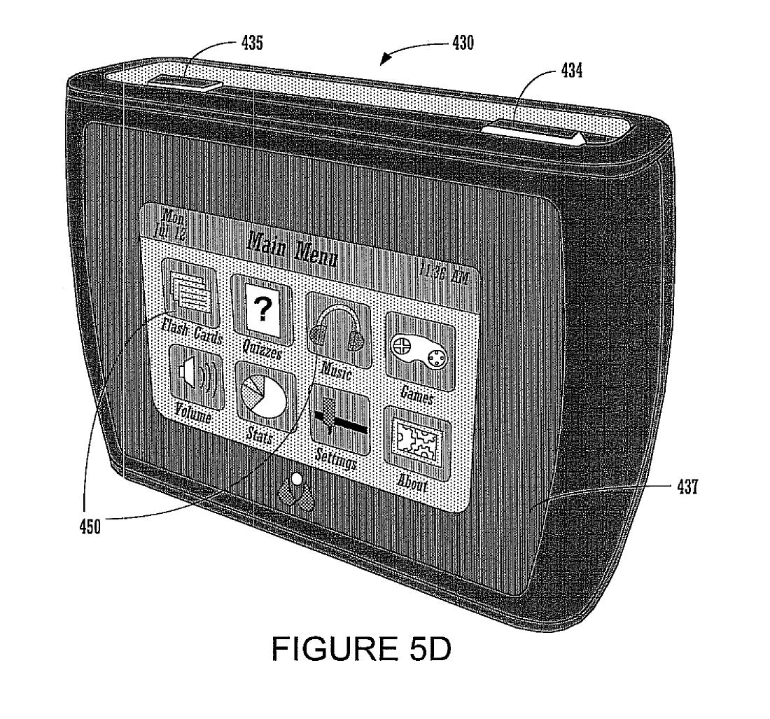

System 105N accesses and correlates sets of flash data 401 and subsequently presents sets of flash data 401 to a user and prompts the user to identify the correlated sets of flash data 401. Moreover, system 105N determines whether a user identification of a set of flash data 401 is correct or not and provides feedback that indicates such (e.g., audio). The components of system 105N are described herein in detail with reference to FIG. 5.

### Operation

FIG. 4C illustrates an exemplary operation of a system for creating and using virtual flash cards 105N according to one embodiment. FIG. 4C shows operations A through F. These operations including the order in which they are presented are only exemplary. In other embodiments, other operations in other orders can be included.

Referring to FIG. 4C, at A, sets of flash data 401 are recorded onto encoded media 405 using the pen computer. In one embodiment, sets of flash data 401 can be written on encoded media 405 using pen computer 403.

At B, corresponding sets of flash data 401 are automatically correlated within memory of the computer pen 403. In one embodiment, sets of flash data 401 are correlated based on the sequence in which the sets of flash data 40 are written onto encoded media. In other embodiments, other manners of correlating sets of flash data 401, as are described herein with reference to FIGS. 4A and 4B, can be used.

At C, a set of flash data 401 is rendered to the user by the computer pen 403. In one embodiment, the set flash data is presented by being read out through a speaker of pen computer 403.

At D, a user is prompted to identify a set of flash data 401 that corresponds to the set of flash data 401 that is rendered at C. The pen computer 403 provides this prompt. And, at E the user selects a set of flash data in an attempt to identify a set of flash data 401 that corresponds to the set of flash data 401 that is rendered at C. The identification may be through a user writing the answer on the encoded paper or selecting an existing writing on the encoded paper, e.g., tapping it.

At F, feedback is provided from the pen computer that communicates the correctness of a user response. In one embodiment, feedback can include an audio message output from the speaker of pen computer 403 that indicates whether or not the selection made at D is correct.

One embodiment of the present invention includes a pop-quiz feature. In this embodiment, after sets of flash data 401 have been placed onto encoded media 405 and correlated by system 105N, system 105N (via optical pen 403) can automatically create virtual flash cards for quizzing a user regarding data associations. For instance, system 105N (via optical pen 403) can read out one set of flash data 401 and can cue the user to write down the associated set of flash data 401 using pen computer 403. In one embodiment, system 105N (via speaker of optical pen 403) can provide instant feedback related to the correctness of an answer. In one embodiment, system 105N can track the percentage of the answers provided by a user that are correct and can automatically determine which associations are problematic for a user. In one embodiment, system 105N can then test these associations with more frequency and can report progress to the user.

In one embodiment, system 105N can encompass components that implement a process to provide more questions similar to the ones that a user does not answer satisfactorily. In one embodiment, a user can create their own quiz based on one or more quiz templates.

### Operating Platform and Operation of Handheld Embodiment

FIGS. 5A-5D show an operating platform and illustrate the operation of a handheld embodiment of the present invention. FIG. 5A shows a computer system 420 upon which virtual flash cards can be created and a handheld virtual flash card control module 430 upon which components of system for creating and using virtual flashcards 105N can operate according to one embodiment of the present invention. FIG. 5A shows computer system 420, handheld virtual flashcard control module 430, memory 431, processor 433, control button 434, control button 435, display screen 437, virtual flash cards 439 and SCUFC 105N.

In one embodiment, handheld virtual flash card-module 430 can include, audio player, e.g., mp3, capability. In one embodiment, handheld virtual flash card module 430 has sufficient memory for hundreds of songs or more, and thousands of flash cards. In addition, handheld virtual flash card control module 430 can be equipped with a jack to accommodate ear plugs. In one embodiment, when the virtual flash card modality is enabled, music play back can be eliminated if desired.

In one embodiment, a user can navigate between the aforementioned, audio player modality and a flashcard modality by utilizing a menu that can be accessed through the use of UP, DOWN, LEFT and RIGHT buttons (for example d-pad not shown) to scroll through menu items (see 450 in FIG. 5D). Referring to FIG. 5D, a main menu item can be launched by pressing control button 434 and a selection entered by pressing control button 435. In one embodiment, display screen 437 (see perspective view shown in FIG. 5C with screen rocker 438) can be used to scroll between flash cards. In one embodiment, deflecting the display screen 437 leftward causes a change from a current flash card to a previous flash card and deflecting display screen 437 rightward causes a change from a current flash card to the next available flash card.

FIG. 5B illustrates how virtual flash cards 439 are rendered on the display screen 437 of virtual flash card control module 430 according to one embodiment of the present invention. In one embodiment, once the flash card program is launched, virtual flash cards 439 can be flipped (causing a change to be made from a display of one side of a virtual flash card 439 to a display of the other side of a virtual flash card 439 as shown in FIG. 5B) by pressing control button 435. In one embodiment, deflecting display screen 437 upward marks a flash card to be repeated, while deflecting display screen 437 downward at any time causes an exit to a flash card menu.

Referring again to FIG. 5A, a user can create virtual flash cards 439 on-line, via computer 420 that can be transferred to handheld virtual flash card control module 430 for use as shown in FIG. 5A. Moreover, instead of, or in addition to being created online, virtual flash cards 439 can be provided by a vendor. After the flashcards created on-line have been transferred to handheld virtual flash card control module 430, in order to quiz a system user, the set of flash data 440 that is contained on the transferred virtual flash cards 439 can be automatically presented to the user on display screen 437. In one embodiment, customization of flash card sessions can be made as flash cards that relate to non-conventional topics that are of interest to a user can be created (e.g., flash cards that help user to learn names of wife's family members).

When flash cards 439 have been transferred to handheld virtual flashcard module 430 a user can be prompted (e.g., audio or video prompting) to identify the virtual flash card 439 that corresponds to the virtual flash card 439 that is automatically presented to the user on display screen 437. In one embodiment, correctly and/or incorrectly identified virtual flash cards can be marked (such as by dog ears) which allows correct and/or incorrect answers to be tracked and recorded in memory. In one embodiment, handheld virtual flashcard control module 430 can produce feedback (e.g., audio, video) that is based on the tracked correct and/or incorrect answers that communicates the flash data correspondences with which a user has difficulty and/or ease.

In one embodiment, system 105N (via module 430) can quiz users on the flash cards. In one embodiment, the order in which virtual flash cards are presented or “flashed” can be selected by a system user. In one embodiment, the order in which virtual flash cards 439 are flashed can be random. In one embodiment, virtual flash cards 439 can be “shuffled.”

In one embodiment, flashcards 439 can be sorted according to topic area such as history, geography, mathematics, vocabulary, etc. Moreover, a user can customize interaction with the system by adding sub-categories to a topic area that is already categorized according to the user's wishes. In one embodiment, the flash cards 439 that are presented can be two sided and can be flagged such as by using “bent ear corner” graphics. In addition, flash cards 439 can have images or sound associated with them (such as an image of a dog on one side of a virtual flash card and the Spanish language term for “dog” being read out in response to a selection of the other side of the virtual flash card).

Referring again to FIG. 5A, system 105N accesses and registers virtual flash cards 439, and their correlations, that are transferred from on-line sources and subsequently causes virtual flash cards 439 to be displayed. Subsequently, system 105N prompts a user to identify virtual flash cards 439 that correspond to displayed virtual flash cards 439. Moreover, system 105N determines whether a user identification of virtual flash cards 439 is correct or not and provides feedback that communicates such (e.g., audio, video).

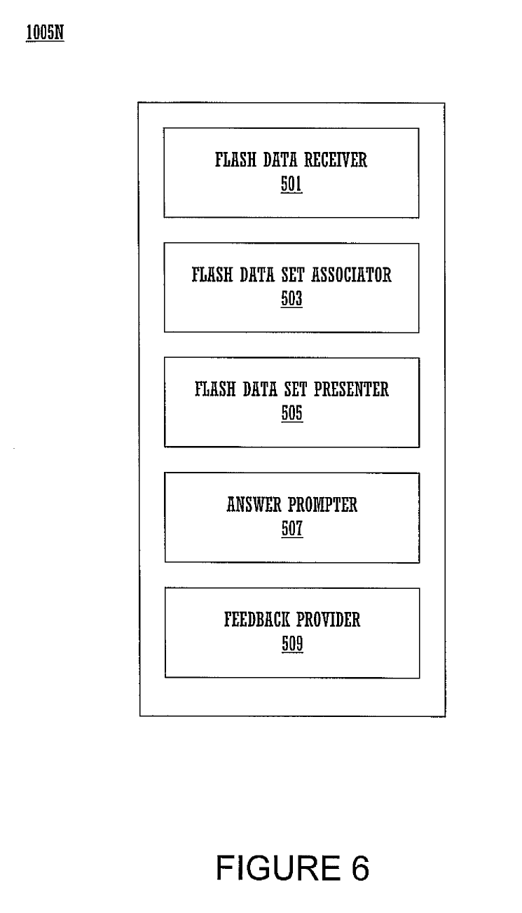

In one embodiment, components of system 105N can be stored in memory 431 of handheld virtual flash card control module 430 and can be executed by resident processor 433. The components of system 105N are described herein in detail with reference to FIG. 6 below.

### Components of System for Creating and Using Virtual Flash Cards According to One Embodiment

FIG. 6 shows components a system for creating and using virtual flash cards 105N according to one embodiment of the present invention. In one embodiment, components of virtual flash card system 105N implement a virtual flash card creation and usage process. In the FIG. 6 embodiment, system 105N includes flash data receiver 501, flash data set associator 503, flash data set presenter 505, answer prompter 507 and feedback provider 505.

It should be appreciated that aforementioned components of system 105N can be implemented in hardware or software or in a combination of both. In one embodiment, components and operations of system 105N can be encompassed by components and operations of one or more computer programs (e.g., 105A in FIG. 1). In another embodiment, components and operations of system 105N can be separate from the aforementioned one or more computer programs but can operate cooperatively with components and operations thereof.

Flash data receiver 501 receives inputs of related sets of flash data (e.g., 401 in FIG. 4A). In one embodiment, the flash data that is received can be written on encoded media (e.g., 405 in FIG. 4A) and read using an optical pen (e.g., 403 in FIG. 4A). In another embodiment, the flash data that is received can be provided by a user into an application program (such as an online application program) where the flash data can be accessed via downloads by flash data receiver of system 105N (see embodiments discussed with reference to FIGS. 5A-5D).

Flash data set associator 503 associates in memory the related sets of flash data (e.g., 401 in FIG. 4A) that are received by flash data receiver 501. In one embodiment, sets of flash data can be associated based on the position of the sets of flash data on encoded media (e.g., 405 in FIG. 4A). In other embodiments, sets of flash data can be associated based on their placement in a sequence of placements of data onto encoded media (e.g., 405 in FIG. 4A).

In still other embodiments, sets of flash data (e.g., 401 in FIG. 4A) can be associated based on user identifications of corresponding sets of flash data such as with an optical pen (e.g., 403 in FIG. 4A). In other embodiments, such as the handheld module embodiments described with reference to FIGS. 5A-5D, flash data sets can be associated based on manual associations made by a user such as into an application program (such as an online application program, see FIGS. 5A-5D). In one embodiment, these manual associations result in the creation of virtual flash cards that can be transferred into a handheld device.

Flash data set presenter 505 presents flash data sets to a system user (student, quiz taker, etc). In one embodiment, the flash data sets can be presented as an audio recitation of the contents of a flash data set (e.g., the read out of words of flash data sets such as “California”, “Sacramento” etc.). In other embodiments, such as are described with reference to FIGS. 5A-5D, the flash data can be graphically presented such as on a display screen of a mobile device.

Answer prompter 507 prompts the provision of an answer in response to the presentation of a set of flash data to a system user. In one embodiment, an audio prompt (a prerecorded sound or voice emanating from optical pen or a hand held module) can be provided. In another embodiment, a video prompt can be provided (e.g., blinking of LED on optical pen or handheld module or blinking graphics on display screen of handheld module). In one embodiment, an answer can be provided such as by contacting the appropriate location on encoded media (e.g., 405 in FIG. 4A) or in another embodiment via input devices (deflectable screen, buttons etc.) of a handheld module (See FIGS. 5A-5D). In one embodiment, a correct answer is the response that has been predetermined determined to be correlated to the flash data that has been presented.

Feedback provider 509 provides feedback that indicates whether or not an answer is correct. In one embodiment, feedback can be provided via speaker associated with an optical pen (e.g., 403 in FIG. 4A) or a handheld module (e.g., 430 in FIG. 5A). In another embodiment, feedback can be provided via a display (for graphical feedback) associated with a handheld module (e.g., 430 in FIG. 5A). Feedback provider 509 can determine a percentage of correct answers that are provided and provide feedback that communicates said percentage of correct answers that are provided. In one embodiment, feedback provider 509 can determine sets of flash data for which incorrect answers have been provided and act to increase the presenting frequency of said sets of flash data for which incorrect answers have been provided.

### Exemplary Operations of System for Creating and Using Virtual Flash Cards According to One Embodiment

FIG. 7 shows a flowchart 600 of the steps performed in a method for creating and using virtual flash cards according to one embodiment. The flowchart shows steps representing processes that, in one embodiment, can be carried out by processors and electrical components under the control of computer-readable and computer-executable instructions. Although specific steps are disclosed in the flowchart, such steps are exemplary. Moreover, embodiments are well suited to performing various other steps or variations of the steps disclosed in the flowchart. Within various embodiments, it should be appreciated that the steps of the flowchart can be performed by software, by hardware or by a combination of both.

Referring to FIG. 7, at step 601 sets of flash data are received. In one embodiment, a flash data receiver (e.g., 501 in FIG. 6) receives inputs of related sets of flash data (e.g., 401 in FIG. 4A). In one embodiment, the sets of flash data that are received, at step 601 can be written on encoded media (e.g., 405 in FIG. 4A) and read using an optical pen (e.g., 403 in FIG. 4A). In another embodiment, the sets of flash data that are received, at step 601, can be provided by a user into an application program (such as an online application program) where the flash data can be accessed by flash data receiver (see embodiments discussed with reference to FIGS. 5A-5D).

At step 603, sets of flash data received in step 601 are associated. In one embodiment, a flash data set associator (e.g., 503 in FIG. 6) associates related sets of flash data (e.g., 401 in FIG. 4A) that are received by the flash data receiver (e.g., 501 in FIG. 6). In one embodiment, sets of flash data can be associated based on the position of the sets of flash data on encoded media (e.g., 405 in FIG. 4A). In one embodiment, related sets of flash data can be associated based on their respective placement positions in the placement sequence of the related flash data sets onto encoded media (e.g., 405 in FIG. 4A). In still other embodiments, sets of flash data (e.g., 401 in FIG. 4A) can be associated based on user identifications of corresponding sets of flash data such as with an optical pen (e.g., 403 in FIG. 4A). It should be appreciated that each of the above manners of association involve manual inputs of sets of flash data that define the relationship between said related sets of said flash data

In other embodiments, such as the handheld embodiments described with reference to FIGS. 5A-5D, flash data sets can be associated based on manual associations made by a user such as into an application program (such as an online application program, see FIGS. 5A-5D). In one embodiment, these manual associations result in the creation of virtual flash cards.

At step 605 a flash data set is presented to a system user. In one embodiment, a flash data set presenter (e.g., 505 in FIG. 6) presents flash data sets to a system user (student, quiz taker, etc). In one embodiment, the flash data sets can be presented using audio output (e.g., the read out of words contained by a virtual flash card such as “California” or “Sacramento” etc.). In other embodiments, such as are described with reference to FIGS. 5A-5D, the flash data can be graphically presented such as on a display screen.

At step 607, the system prompts a system user to respond by answer to a presented virtual flash card or set of flash data. In one embodiment, an answer prompter (e.g., 507 in FIG. 6) prompts the provision of an answer in response to the presentation of a set of flash data to a system user. In one embodiment, an audio prompt (a prerecorded sound or voice emanating from optical pen or a hand held module) can be provided to a system user. In another embodiment, a video prompt can be provided to a system user (e.g., blinking of LED on optical pen or handheld module or blinking graphics on display screen of handheld module). In one embodiment, an answer can be provided such as by contacting the appropriate location on encoded media (e.g., 405 in FIG. 4A) or in another embodiment via input devices (buttons etc.) of a handheld module (see FIGS. 5A-5D). In one embodiment, a correct answer is the response that has been predetermined to correspond to the set of flash data that has been presented or the set of flash data contained in the virtual flash card that has been presented.

At step 609, the system user is provided feedback that indicates whether or not an answer provided by the system user is correct. In one embodiment, a feedback provider (e.g., 509 in FIG. 6) provides the feedback that indicates whether or not an answer provided by the system user is correct.

In accordance with exemplary embodiments thereof, creating and using virtual flash cards is disclosed. A disclosed method includes receiving an input of sets of flash data into a portable handheld device, associating related sets of the flash data based on manual inputs that define the relationship between the related sets of flash data, presenting one of the related sets of flash data via the handheld device and prompting a selection of a set of flash data that is associated with the presented set of flash data. Feedback is provided that indicates whether or not a selected set of flash data is correct.

Embodiments of the present invention are thus described. While the present invention has been described in particular embodiments, it should be appreciated that the present invention should not be construed as limited by such embodiments, but rather construed according to the claims listed below.

What is claimed is:

1. A method for creating and using virtual flash cards, said method comprising:
receiving an input of sets of flash data into a portable handheld device;
associating in computer memory related sets of said flash data based on manual inputs of said sets of flash data that define relationships between said related sets of said flash data;
presenting one of said related sets of flash data via said handheld device;
prompting a selection of a set of flash data that is associated with said one of said related sets of flash data;
receiving an indication of a user supplied response to said prompting; and
providing feedback that indicates whether or not said user supplied response identifies said set of flash data that is associated with said one of said related sets of flash data is correct.

2. The method of claim 1 wherein said receiving comprises receiving inputs of related sets of flash data that are supplied from online sources into a handheld device.

3. The method of claim 1 wherein said receiving comprises scanning sets of said flash data with an optical device that are written onto encoded media using said optical device.

4. The method of claim 1 wherein said associating is based on the writing order of a set of flash data in a writing sequence onto encoded media.

5. The method of claim 1 wherein said associating said related sets of flash data is based on positions of said related sets of flash data on a surface of encoded media.

6. The method of claim 1 wherein said presenting comprises rendering audio content on said handheld device and wherein said handheld device is a hand held module.

7. The method of claim 1 wherein said presenting comprises an audio rendering of a set of flash data from said handheld device and wherein said handheld device is an optical pen computer.

8. The method of claim 1 further comprising determining a percentage of correct answers that are provided and providing feedback that communicates said percentage of correct answers.

9. The method of claim 1 further comprising determining sets of flash data for which incorrect answers are provided and increasing the frequency with which prompting for said sets of flash data is made.

10. An optical device comprising:
an optical detector;
a processor coupled to said optical detector; and
a memory coupled to said processor and comprising instructions that when executed implement a method comprising:
receiving an input of sets of flash data into said optical device;
associating in said memory related sets of said flash data based on manual inputs of said sets of flash data that define relationships between said related sets of said flash data;
presenting one of said related sets of flash data via said optical device;
prompting a selection of a set of data that is associated with said one of said related sets of flash data;
receiving an indication of a user supplied response to said prompting; and
providing feedback that indicates whether or not said user supplied response identifies said set of flash data that is associated with said one of said related sets of flash data.

11. The device of claim 10 wherein said receiving comprises scanning sets of said flash data with said optical device that have been written onto encoded media using said optical device.

12. The device of claim 10 wherein said associating said related sets of flash data is based on positions of said related sets of flash data on a surface of encoded media.

13. The device of claim 10 wherein said associating is based on a writing order of a set of flash data in a writing sequence onto encoded media.

14. The device of claim 10 wherein said presenting comprises an audio rendering of a set of flash data from said optical device.

15. The device of claim 10 wherein said method further comprises determining a percentage of correct answers that are provided and providing feedback that communicates said percentage of correct answers provided.

16. The device of claim 10 wherein said method further comprises determining sets of flash data for which incorrect answers are provided and increasing the frequency with which prompting for said sets of flash data is made.

17. A handheld device comprising:
an input port for receiving digital data;
a deflectable display screen coupled to said input port;
a processor coupled to said display screen; and
a memory coupled to said processor, and comprising instructions that when executed implement a method comprising:
receiving an input of related sets of flash data into said portable device;
presenting one of said related sets of flash data via said display screen;
prompting a selection of a set of data that is associated with said one of said related sets of flash data; and
in response to a user action, presenting via said display screen a set of flash data associated with said on of said related sets of flash data.

18. The device of claim 17 wherein said receiving comprises receiving inputs of related sets of flash data that are supplied from online sources and are provided as input into said input port of said handheld device.

19. The device of claim 17 wherein said associating said related sets of data is performed online.

20. The device of claim 17 wherein said presenting comprises the display of graphical flashcard on said display screen wherein said graphical flashcard can be manipulated by deflecting said display screen.
